(19) United States
(12) Patent Application Publication
(10) Pub. No.: US 2023/0317312 A1
(43) Pub. Date: Oct. 5, 2023

(54) THERMALLY CONDUCTIVE FLAT SELF-FUSING ENAMELED WIRE

(71) Applicant: JUNG SHING WIRE CO., LTD., Tainan City (TW)

(72) Inventor: Tung-Tzer WANG, Tainan City (TW)

(21) Appl. No.: 17/709,775

(22) Filed: Mar. 31, 2022

(51) Int. Cl. H01B 3/08; H01B 3/12; H01B 7/00; H01B 7/42

(52) U.S. Cl. CPC H01B 3/081; H01B 7/428; H01B 7/0018; H01B 3/12

(57) ABSTRACT

A thermally conductive flat self-fusing enameled wire includes a flat metal conducting wire core, a thermally conductive insulator layer surrounding the flat metal conducting wire core to cover the same, and a thermally conductive insulating fusion layer surrounding the thermally conductive insulator layer to cover the same. The thermally conductive insulator layer is made at least from a polyamide-imide based polymer having a repeating unit of 4,4′-stilbenediamide group, and a ceramic material.

### FIELD

The disclosure relates to a wire, and more particularly to a thermally conductive flat self-fusing enameled wire.

### BACKGROUND

A conventional enameled wire includes a metal wire core and an insulating layer surrounding the metal wire core to cover the same. For example, JP 2018053061 discloses an electric insulating wire that comprises a conductor and an electric insulating coating coated on the conductor. The electric insulating coating may be made from a thermally conductive electric insulating material.

Generally speaking, a plurality of the conventional enameled wires are subjected to embedding and wire arrangement to prepare coil modules including a plurality of coils. The coil modules are subjected to a fixation treatment to obtain a coil winding unit (e.g. a stator winding unit or a rotor winding unit) applicable to motors. The fixation treatment includes gluing and curing. Only through the fixation treatment, the adjacent coils in the coil modules can be bonded to one another and remain unseparated. Therefore, the process of preparing a coil winding unit using the conventional enameled wires is complicated, being unable to enhance the production efficiency of coil winding unit.

In view of the foregoing, there is still a need to develop an enameled wire that is not required to be subjected to gluing in preparing a coil winding unit, and that can hence enhance the production efficiency of coil winding unit.

### SUMMARY

Therefore, an object of the disclosure is to provide a thermally conductive flat self-fusing enameled wire which can alleviate at least one of the drawbacks of the prior art. The thermally conductive flat self-fusing enameled wire includes a flat metal conducting wire core, a thermally conductive insulator layer surrounding the flat metal conducting wire core to cover the flat metal conducting wire core, and a thermally conductive insulating fusion layer surrounding the thermally conductive insulator layer to cover the thermally conductive insulator layer. The thermally conductive insulator layer is made at least from a polyamide-imide based polymer having a repeating unit of 4,4′-stilbenediamide group, and a ceramic material.

### BRIEF DESCRIPTION OF THE DRAWINGS

Other features and advantages of the disclosure will become apparent in the following detailed description of the embodiment(s) with reference to the accompanying drawings, of which:

FIG. 1 is a fragmentary, sectioned perspective view illustrating an embodiment of a thermally conductive flat self-fusing enameled wire according to the present disclosure.

### DETAILED DESCRIPTION

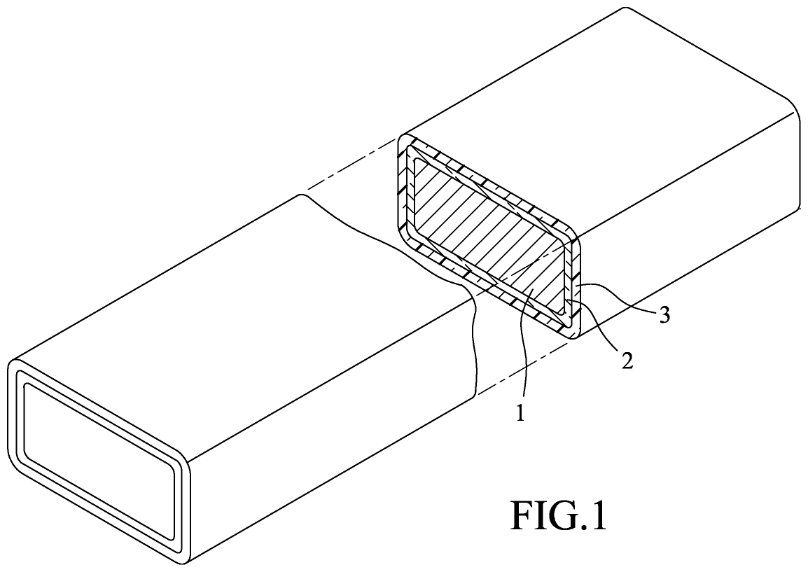

Referring to FIG. 1, an embodiment of a thermally conductive flat self-fusing enameled wire according to the present disclosure includes a flat metal conducting wire core 1, a thermally conductive insulator layer 2, and a thermally conductive insulating fusion layer 3.

Examples of the flat metal conducting wire core 1 include, but are not limited to, a flat copper conducting wire core, a flat aluminum conducting wire core, and a flat copper-clad aluminum conducting wire core.

The thermally conductive insulator layer 2 surrounds the flat metal conducting wire core 1 to cover the flat metal conducting wire core 1, and is made at least from a polyamide-imide based polymer having a repeating unit of 4,4′-stilbenediamide group, and a ceramic material.

Examples of the polyamide-imide based polymer include, but are not limited to, a polyamide-imide based polymer represented by the following formula

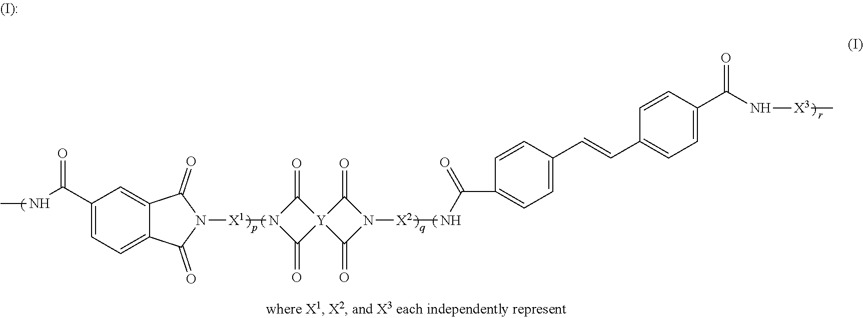

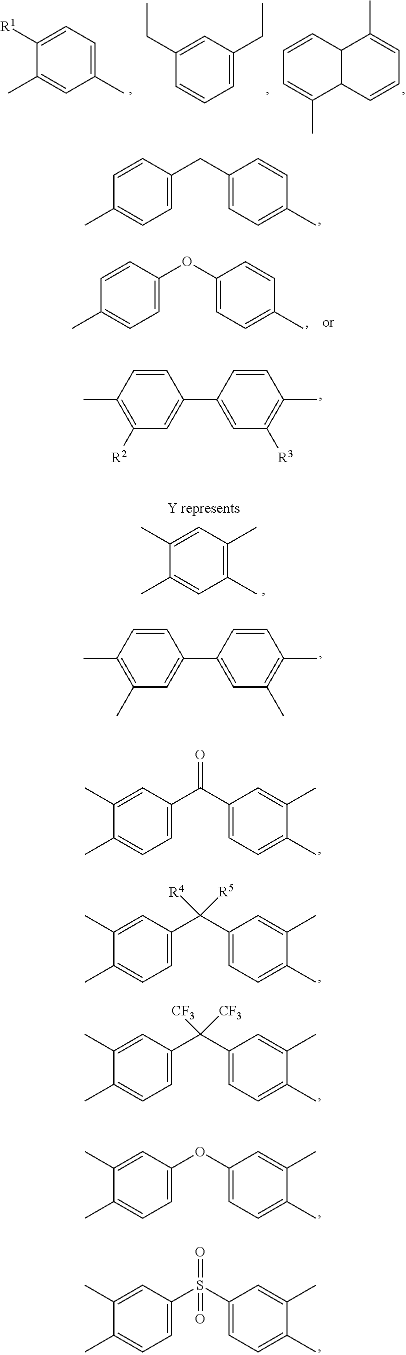

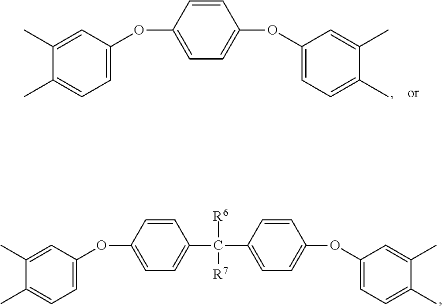

R¹ to R⁷ each independently represent a hydrocarbon group, p is 0 to 95, q is 1 to 50, and r is 1 to 80. When p, q, or r is not less than 2, X¹, X², X³, Y, R¹, R², R³, R⁴, R⁵, R⁶, and R⁷ are identical or different.

For example, p is 0 to 75, q is 5 to 50, and r is 20 to 80. For further example, p is 0, q is 20 to 50, and r is 50 to 80. For still further example, p is 5 to 75, and q is 20 to 80.

Examples of the hydrocarbon group include, but are not limited to, an alkyl group, an alkenyl group, and an aromatic group. Examples of the alkyl group include, but are not limited to, a methyl group and an ethyl group. Examples of the alkenyl group include, but are not limited to, a vinyl group. Examples of the aromatic group include, but are not limited to, a phenyl group and a naphthyl group.

The polyamide-imide based polymer may be prepared by subjecting a diisocyanate material, 4,4′-stilbenedicarboxylic acid, and a carboxylic acid dianhydride material to a polymerization reaction. The diisocyanate material may be hydrocarbon phenyl diisocyanate, xylylene diisocyanate (XDI), 1,5-naphthalene diisocyanate (NDI), diphenylmethane diisocyanate (MDI), diphenylether-4,4′-diisocyanate, or 3,3′-dihydrocarbon-4,4′-biphenylene diisocyanate. The hydrocarbon phenyl diisocyanate may be toluene diisocyanate (TDI). The 3,3′-dihydrocarbon-4,4′-biphenylene diisocyanate may be 3,3′-dimethyl-4,4′-biphenylene diisocyanate (TODI). The carboxylic acid dianhydride material may be pyromellitic anhydride (PMDA), 3,3′,4,4′-diphenyltetracarboxylic dianhydride (BPDA), 3,3′,4,4′-benzophenonetetracarboxylic dianhydride (BTDA), 4,4′-(hexafluoroisopropylidene)diphthalic anhydride, 4,4′-(dihydrocarbon)methyldiphthalic anhydride (i.e.

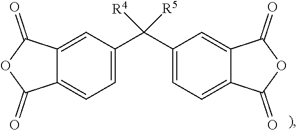

), 4,4′-oxydiphthalic anhydride (ODPA), 3,3′,4,4′-diphenylsulfonetetracarboxylic dianhydride (DSDA), 3,3′,4,4′-triphenylbiethertetracarboxylic dianhydride, or 4,4′-[4,4′-(dihydrocarbon)methyldiphenoxy]bis(phthalic anhydride) (i.e.

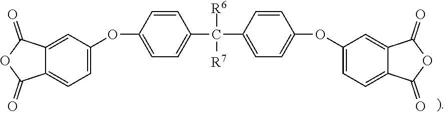

). The 4,4′-(dihydrocarbon)methyldiphthalic anhydride may be 4,4′-isopropylidenediphthalic anhydride. The 4,4′-[4,4′-(dihydrocarbon)methyldiphenoxy]bis(phthalic anhydride) may be 2,2-bis(4-phenoxyphenyl) propanetetracarboxylic dianhydride (BPADA).

Examples of the ceramic material include, but are not limited to, aluminum oxide, boron nitride, aluminum nitride, and silicon carbide.

The thermally conductive insulator layer 2 may be made further from an additive (in addition to the polyamide-imide based polymer and the ceramic material). Examples of the additive include, but are not limited to, a lubricant, a cross-linking agent, an antioxidant, a colorant, a flame retardant, and a reaction catalyst. The lubricant may be wax, a fatty acid ester, or polyethylene with a low molecular weight. The cross-linking agent may be a silane coupling agent. The antioxidant may be an antioxidant having a phenol structure.

The thermally conductive insulator layer 2 may have a thermal conductivity coefficient that is not less than 0.35 W/m·K.

The thermally conductive insulating fusion layer 3 surrounds the thermally conductive insulator layer 2 to cover the thermally conductive insulator layer 2.

The thermally conductive insulating fusion layer 3 may be made from a polymer, a curing agent, a nano heat-dissipating material, and a solvent.

The polymer may be selected from the group consisting of a thermoplastic polymer and a combination of the thermoplastic polymer and a thermosetting polymer. The thermoplastic polymer may be nylon. The thermosetting polymer may be an epoxy resin.

The curing agent is used for the polymer to undergo cross-linking. Therefore, the type of the curing agent is determined based on the type of the polymer. Since the curing agent may be a curing agent well-known in the art, the detail thereof is omitted herein for the sake of brevity.

The type of the nano heat-dissipating material is determined based on the thermal conductivity required by the thermally conductive insulating fusion layer 3, and may be a heat-dissipating material well-known in the art, for instance, aluminum oxide, boron nitride, aluminum nitride, or silicon carbide.

The type of the solvent is determined based on the types of the polymer, the curing agent, the nano heat-dissipating material. Since the solvent may be a solvent well-known in the art, the detail thereof is omitted herein for the sake of brevity.

The thermally conductive insulating fusion layer 3 may have a thermal conductivity coefficient that is not less than 0.30 W/m·K, and a thickness that is not greater than 15 μm.

By virtue of the thermally conductive insulating fusion layer 3 that can be melted under heat, when a plurality of the thermally conductive flat self-fusing enameled wires are subjected to embedding and wire arrangement to prepare coil modules, the coil modules can be directly heated for the fusion to proceed, so that the thermally conductive insulating fusion layers 3 of the thermally conductive flat self-fusing enameled wires are in a melted state. Therefore, the adjacent thermally conductive flat self-fusing enameled wires can be fused together through the melted thermally conductive insulating fusion layers 3. After solidification, the adjacent thermally conductive flat self-fusing enameled wires are bonded and fixed together, thereby obtaining a coil winding unit. Accordingly, gluing can be dispensed with, and the production efficiency of coil winding unit can be enhanced.

Based on the cooperation of the thermally conductive insulator layer 2 and the thermally conductive insulating fusion layer 3, the thermally conductive flat self-fusing enameled wire of the present disclosure can effectively transfer heat outwardly, hence having a satisfactory heat-dissipating ability.

The thermally conductive flat self-fusing enameled wire of the present disclosure can be applied to, for example, a stator winding unit or a rotor winding unit for motors of electric vehicles.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, FIGURE, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A thermally conductive flat self-fusing enameled wire comprising:
a flat metal conducting wire core;
a thermally conductive insulator layer surrounding said flat metal conducting wire core to cover said flat metal conducting wire core, said thermally conductive insulator layer being made at least from a polyamide-imide based polymer having a repeating unit of 4,4′-stilbenediamide group, and a ceramic material; and
a thermally conductive insulating fusion layer surrounding said thermally conductive insulator layer to cover said thermally conductive insulator layer.

2. The thermally conductive flat self-fusing enameled wire according to claim 1, wherein said thermally conductive insulating fusion layer is made from a polymer, a curing agent, a nano heat-dissipating material, and a solvent.

3. The thermally conductive flat self-fusing enameled wire according to claim 2, wherein said polymer is selected from the group consisting of a thermoplastic polymer and a combination of the thermoplastic polymer and a thermosetting polymer.

4. The thermally conductive flat self-fusing enameled wire according to claim 1, wherein said thermally conductive insulating fusion layer has a thermal conductivity coefficient that is not less than 0.30 W/m·K.

5. The thermally conductive flat self-fusing enameled wire according to claim 1, wherein said thermally conductive insulating fusion layer has a thickness that is not greater than 15 μm.

6. The thermally conductive flat self-fusing enameled wire according to claim 1, wherein said thermally conductive insulator layer has a thermal conductivity coefficient that is not less than 0.35 W/m·K.

7. The thermally conductive flat self-fusing enameled wire according to claim 1, wherein said polyamide-imide based polymer is a polyamide-imide based polymer represented by the following formula (I): 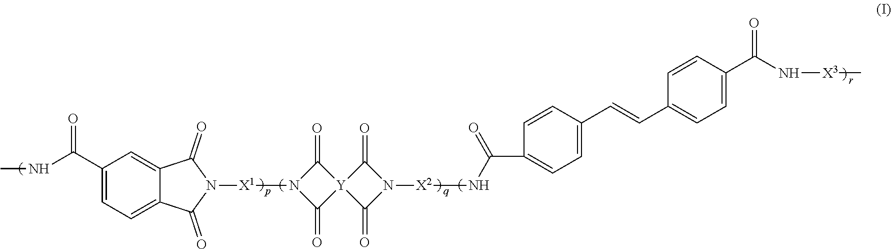
where X¹, X², and X³ each independently represent 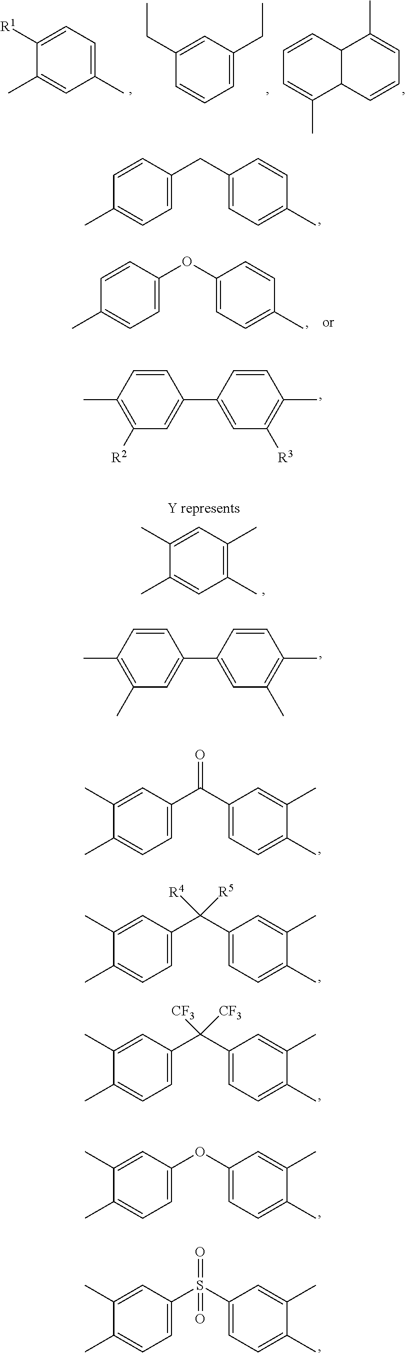 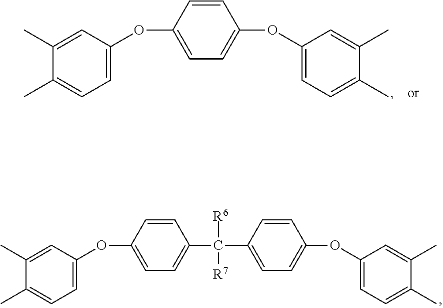
R¹ to R⁷ each independently represent a hydrocarbon group, p is 0 to 95, q is 1 to 50, and r is 1 to 80, X¹, X², X³, Y, R¹, R², R³, R⁴, R⁵, R⁶, and R⁷ being identical or different when p, q, or r is not less than 2.

8. The thermally conductive flat self-fusing enameled wire according to claim 1, wherein said ceramic material is selected from the group consisting of aluminum oxide, boron nitride, aluminum nitride, silicon carbide, and combinations thereof.
